(19) United States
(12) Patent Application Publication
(10) Pub. No.: US 2002/0100039 A1
(43) Pub. Date: Jul. 25, 2002

(54) Media interactivity method and architecture

(76) Inventors: Nicholas Iatropoulos, Astoria, NY (US); Alexios Vratskides, Thessaloniki (GR)

Correspondence Address: DENIS G. MALONEY, Fish & Richardson P.C., 225 Franklin Street, Boston, MA, 02110-2804, US

(21) Appl. No.: 09/766,380

(22) Filed: Jan. 19, 2001

(51) Int. Cl. H04N 7/173; H04N 7/16; H04H 9/00; H04N 7/08

(52) U.S. Cl. 725/24; 725/16; 725/135; 725/137; 725/113

(57) ABSTRACT

A mechanism for enabling interactive communications between mass media operators and mass media audiences is described. The mechanism associates an interactive prompt with a communication over a communications medium so that the prompt is received by a member of a mass media audience member and receives a response from the mass media audience member in response to the interactive prompt from a communications device.

### BACKGROUND OF THE INVENTION

The invention relates to interactive media.

Traditional mass media employ various techniques to engage customers in an interactive dialog. For example, printed media sometimes employ special advertising codes for this purpose. Radio and television broadcast operators use call centers and Web-site e-mail solicitation as well as interactive television (ITV) to obtain feedback from an audience. Perhaps the most effective of the tools available to television broadcasting is ITV, but there remain significant barriers to its wide-scale deployment. There is no clear way for mass media operators to receive and process feedback and interaction from their audience in real-time, as the absorption of the media content occurs.

### SUMMARY OF THE INVENTION

The invention features a mechanism that enables real-time interactivity between mass media operators, e.g., television stations, radio stations and print, and their respective audiences.

In one aspect of the invention, interactive communication between mass media operators and mass media audiences is enabled. An interactive prompt is associated with a communication of a mass communications medium so that the interactive prompt is received by an audience. A response is received from the audience member in response to the interactive prompt using a communications device.

One or more aspects of the invention may include one or more of the following advantages.

The interactivity architecture of the invention may be adopted by media users and their customers (viewers) without costly changes to existing media infrastructure. Also, the architecture provides users of the technology (that is, the media operators) with a simple tool with which to obtain knowledge of their audience and offers viewers simple, yet powerful ways to interact with programs.

Other features and advantages of the invention will be apparent from the following detailed description and from the claims.

### BRIEF DESCRIPTION OF THE DRAWINGS

FIG. 1 is a block diagram of a communications environment enabling interactivity between mass media operators and mass media audiences.

FIG. 2 is a block diagram of a server system that operates in conjunction with a client system to enable interactivity.

FIGS. 3A through 3F are exemplary screen displays from a Graphical User Interface (GUI) used in rendering pages at the client system for interactive content.

FIG. 4 is a depiction of the data flow within the system of FIG. 1.

### DETAILED DESCRIPTION

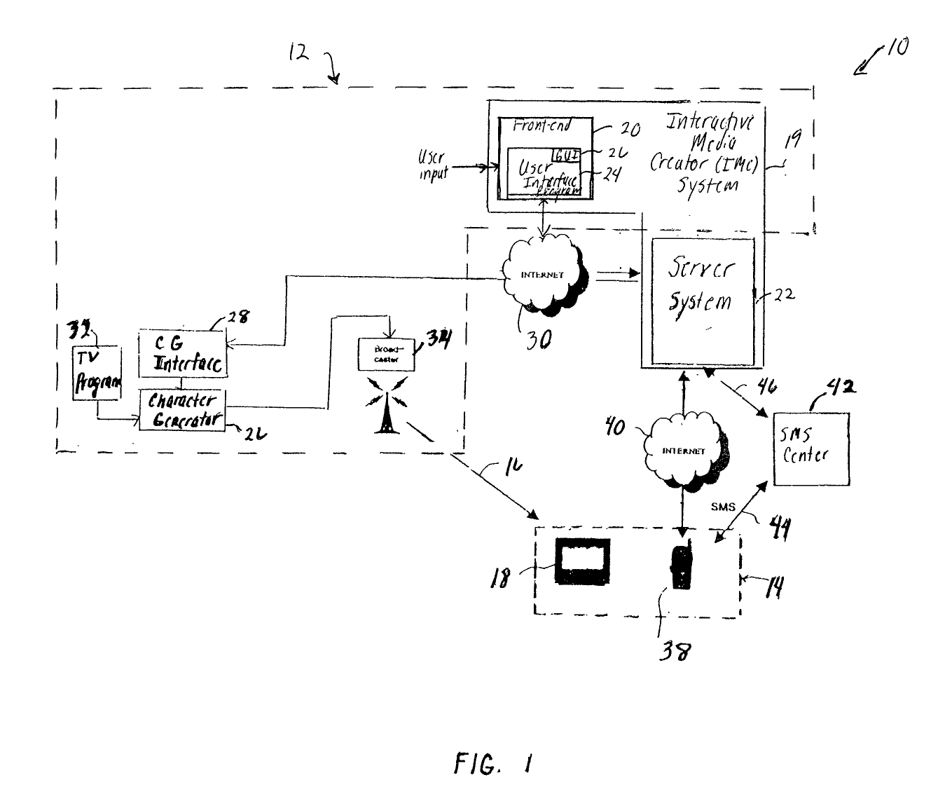

Referring to FIG. 1, a communications environment 10 includes a facility 12 operated by a mass communications medium operator that communicates with a station 14 over a medium 16. The medium 16 may be any medium or delivery vehicle capable of delivering communications from the mass communications medium facility 12. In one embodiment (as illustrated), the mass communications medium facility 12 is located in a television (TV) broadcast facility and the station 14 is an audience station that represents a member of an audience and includes, for an audience member, a television 18 viewed and operated by the audience member.

Although the communications environment 10 is illustrated for the television broadcast embodiment, other embodiments are radio broadcast and printed media. In the radio broadcast embodiment, the facility 12 is a radio broadcast facility and the station 14 includes a radio instead of the television 18 shown in the figure. In the printed media embodiment, the facility 12 is a printed media facility and the audience represented by the station 14 does not include a special receiving device, such as a television or radio as used in the television and radio embodiments, respectively.

It will be appreciated that the communications environment 10 could include a plurality of such stations, one for each intended recipient of communications delivered by facility 12, or more specifically, in the television broadcast embodiment, one for each audience member. In that same embodiment, the communication is a television program and the medium 16 is a transmission or delivery medium for delivering the television program to the entity 14. Thus, the medium 16 may be cable, satellite, terrestrial (i.e., by wire or telephone lines), aerial (i.e., by radio waves) or any other medium through which such broadcasts can be delivered.

The system environment 10 further includes a system 19 (hereinafter referred to as an Interactive Media Creator or “IMC” system) that includes a front-end 20 and a server 22. The front-end 20 resides in the television facility 12 as shown. The front-end system 20 includes a front-end user interface program 24 with a graphical user interface (GUI) 26 through which a media client representative of the IMC system 19 can input data. The front-end user interface program 24 may be implemented as a Visual Basic program or an HTML client program. The television facility 12 further includes a character generator system 26 connected to a character generator interface 28. The CG interface 28 and the front-end 20 are coupled to the server 22 by an Internet connection 30. The character generator interface 28 receives an interactive prompt generated by the IMC system 19 from the server 22, and translates the interactive prompt into a form that is understood by the character generator 26. The character generator 26 inserts the interactive prompt into a television program 32. The TV facility 12 further includes a broadcaster 34, which is coupled to the CG 26. The CG 26 provides the program with interactive prompt data (interactive content) to the broadcaster 34, which in turn broadcasts the program immediately for a live broadcast or at a scheduled time for a scheduled broadcast via the transmission medium 16.

Although the facility 12 includes a CG interface having middleware for interfacing the IMC system server 34 to the CG 26, a stand-alone character generator could be used. In one such solution, the IMC system server 22 could communicate directly with software of the CG 26. Alternatively, if the IMC system 20 cannot communicate directly with the character generator, the IMC system server 22 could send the prompt data to an operator (of the CG 26) for manual entry.

It will be understood that in the radio and printed media embodiments, as discussed earlier, the character generator 26 and CG interface 28 are not present. Additionally, for a printed media embodiment, the broadcaster 34 is not used.

It will be further understood that a character generator may not required for the illustrated television embodiment. That is, other techniques may be used to overlay the prompt on the program. The placement of the prompt over the program may be performed manually, for example, by a postproduction graphics team. Alternatively, the prompt may not be included in the program in text format at all, but rather as an audio (voice) overlay and thus may be read by an announcer or otherwise converted to speech for audio play during the program.

As indicated above, the IMC system front-end 20 is coupled to the server 22 by the Internet connection 30. The IMC system front-end 20 communicates with the server 22 according to the well-known Hypertext Transfer Protocol (HTTP).

The station 14 further includes a communications device 38, with which the audience member is capable of communicating with the server 22 through a second Internet connection 40. The second Internet connection 40 may be a wired or wireless Internet connection. In the illustrated embodiment, the communications device is a wireless device such as mobile telephone. Other types of communications devices, such as handheld devices (e.g., personal assistants, palmtop computers), portable or personal computers, may be used. Any type of communications device that is able to communicate with the server 22 using a Web-based protocol may be used. Types of supported Web-based protocols include, but are not limited to, HTTP, and, for wireless communications, Wireless Access Protocol (WAP).

Alternatively, or in addition to the Internet connection 40, the station 14 (or more specifically, the communications device 38) may connect to the server 22 via a Short Message Service (SMS) Center 42, which receives SMS communications (indicated by a reference number 44) from the communications device 38 according to known SMS protocol. The SMS Center 42 converts the SMS communications to a format that conforms to SMPP protocol and sends the SMPP-based communications 46 to the server 22.

Still referring to FIG. 1, an overview of a process by which interactivity between the facility 12 and the station 14 occurs is as follows. The IMC system front-end 20 uses the GUI 26 of the media client interface 22 in conjunction with the server 22 to prepare an interactive prompt to appear during a television program 30. Typically, the interactive prompt requests some type of input from a viewer of the program and provides the request in the form of a question or set of questions. For example, if the program is a political debate, the prompt may poll viewers to ascertain which candidate viewers believe to be the winner of the debate. Thus, in this example, the prompt invites viewers to respond by voting for a candidate as the debate winner.

The prompt is prepared at the IMC system front-end 20, saved at the IMC system server 22 and provided to the character generator 26 via the Internet connection 30 and the CG interface 28. The character generator 26 inserts the prompt into the broadcast signal that produces the television program. The program with the interactive prompt is broadcast by the broadcaster 34 to each viewer's television set (the television 18) over the transmission medium 16.

As earlier indicated, viewers respond to the prompt when the prompt appears on their television screens using the communications device 14. The server 22 receives each response and dynamically updates a database entry with the requested response data (in the example of the political debate, the votes received from viewers). The response data are processed according to the type of question that was created by the media client in the IMC front-end 20. The server 22 provides the results to the front-end 20 for viewing by a producer or other users of the IMC system front-end 20. In addition, the server 22 may provide results to the CG interface 28 for display on the TV set 18 in real-time as responses are received. The results may or may not be updated on the screen.

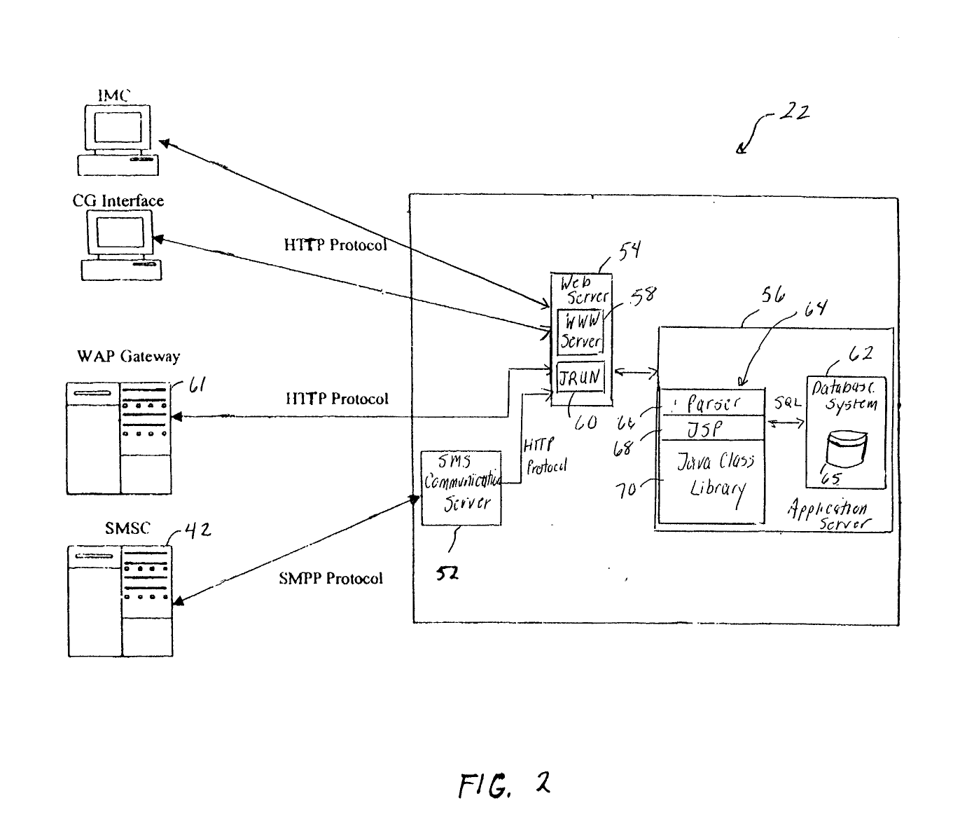

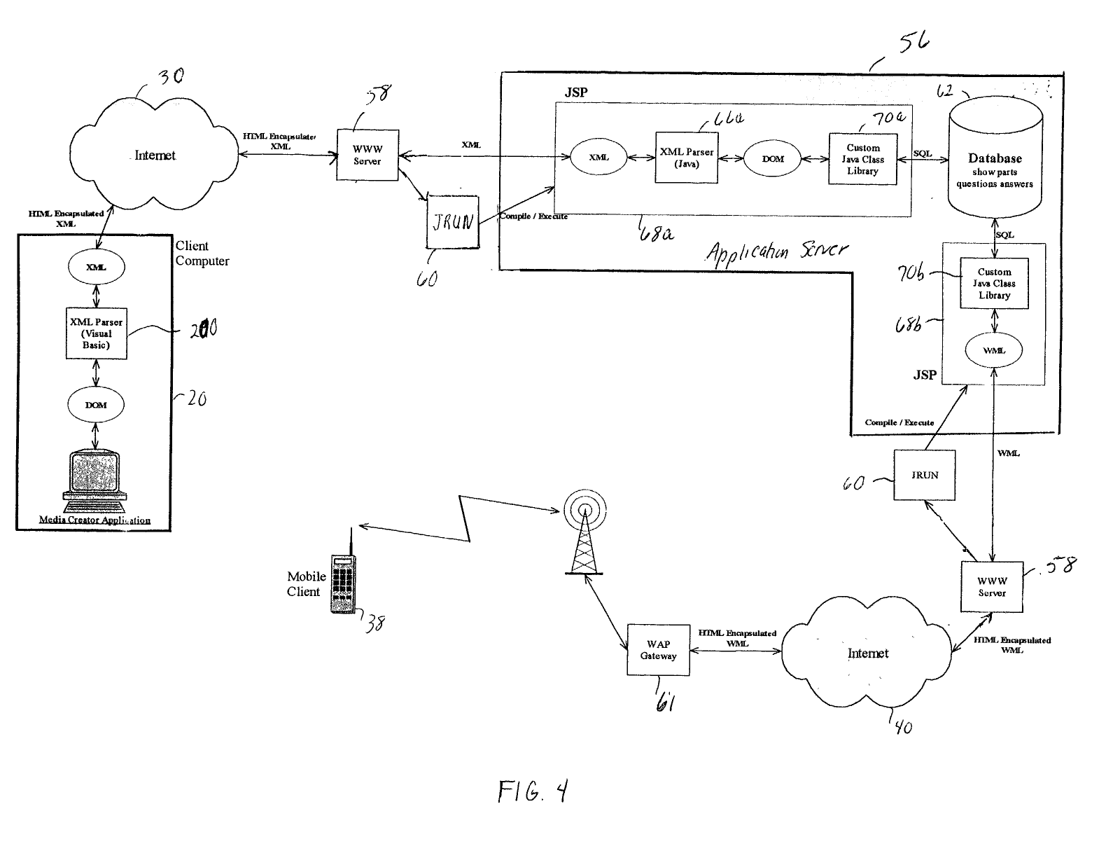

Referring to FIG. 2, the server 22 includes an SMS Communication Server 52 for re-formatting communications from the SMSC 42 in SMPP protocol as HTTP, and well as a Web server 54 and an applications server 56. The Web server 54 includes a World Wide Web (WWW) server 58 and a Java compiler program (“JRUN”) 60. The WWW server 58 communicates in HTTP format directly with the IMC system front-end 20 and the CG interface 28 (from FIG. 1), as well as a WAP gateway 61 and the SMS Communication Server 52. The application server 56 includes a database system 62 and database access application programs 64. The database system 58 supports a database 65 and performs database management functions. In one embodiment, the database system 62 is a relational database system and may be implemented with a commercially available relational database system, such as those available from Oracle™. The programs 64 include an eXtensible Markup Language (XML) parser written in Java 66, a Java Server Pages (“JSP”) 68 and a custom Java class library 70. The functionality of these programs will be described with reference to FIG. 4 below.

In a conventional TV production and broadcasting business, the production process includes the following functions: a producer, a selector, a linker (traffic blending), a graphic scheduler and a playout. After the producer completes production of various programs, the selector performs content programming (i.e., show scheduling, which views shows as discrete events with a duration) for a facility for any given day. The linker merges commercial content with each show or program. A log of the programming for the day is then transferred to the graphics scheduler. The graphics scheduler re-arranges or adds to program content as necessary. For example, the graphics scheduler may insert into a program text that is overlaid on a broadcast (hereinafter referred to singularly as a “Crawl” and collectively as “Crawls”). The actual text as well as the timing and duration of the Crawl is communicated to the graphic scheduler by the producer using any appropriate communications mechanism, such as e-mail. The programming log is finalized prior to air-time, at which point the program is released to the playout function for execution.

Referring back to FIG. 1, the IMC system 19 is a tool that gives the TV facility 12 the ability to enable interactive audience feedback, for example, post live or schedule surveys, polls, competitions, etc. Users of the IMC system 19 may include individuals performing such functions as the TV producer and graphic scheduler functions described above. The producer uses the IMC system 19 to generate content for a particular type of Crawl, that is, the interactive prompt, and to place that interactive prompt within the relative duration of a show. The graphic scheduler inserts the interactive prompt in the TV broadcast and schedules it within the TV schedule for a given day. The graphics scheduler also schedules the server system 34 to ready an event Web/WAP-site to serve a page 64b corresponding to the interactive prompt and to expect responses (or “hits”) from audience members or viewers at the same or approximately the same time.

Again, and as indicated earlier, the communication environment 10 is not limited to television broadcast. The interactivity enabling architecture of IMC system 19 supports television, radio and print with television, radio and print-specific implementations of the user interface 24 and GUI 26 in the front-end 20.

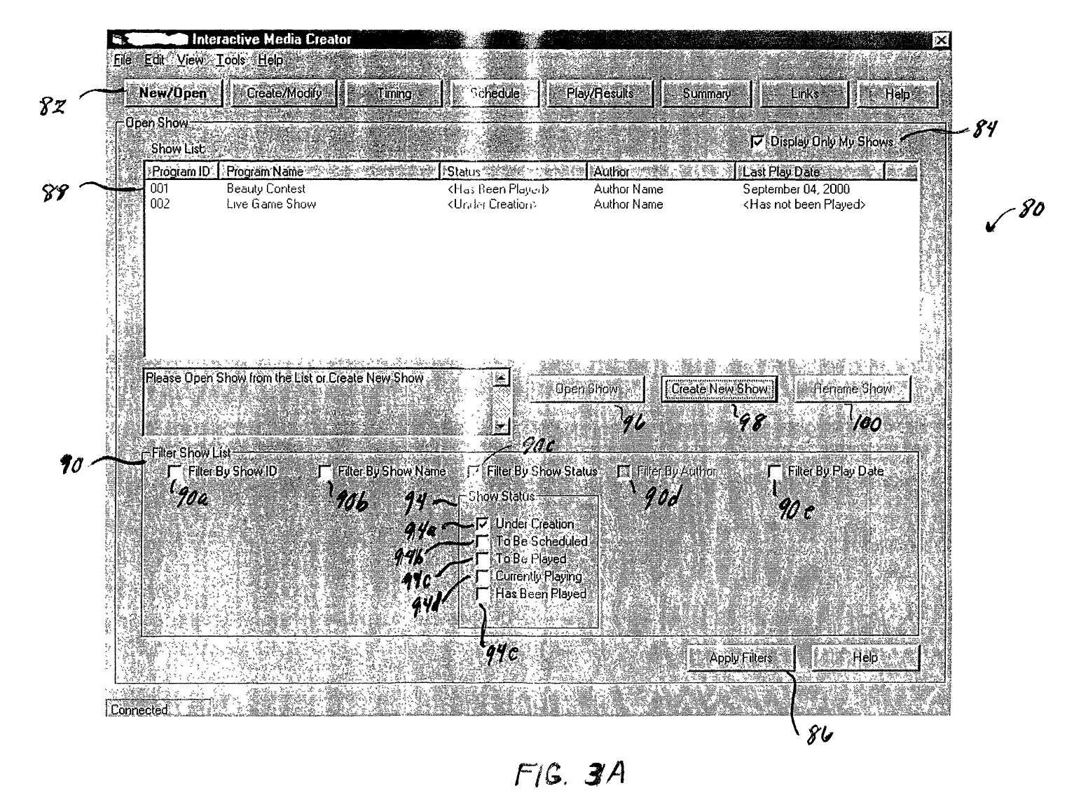

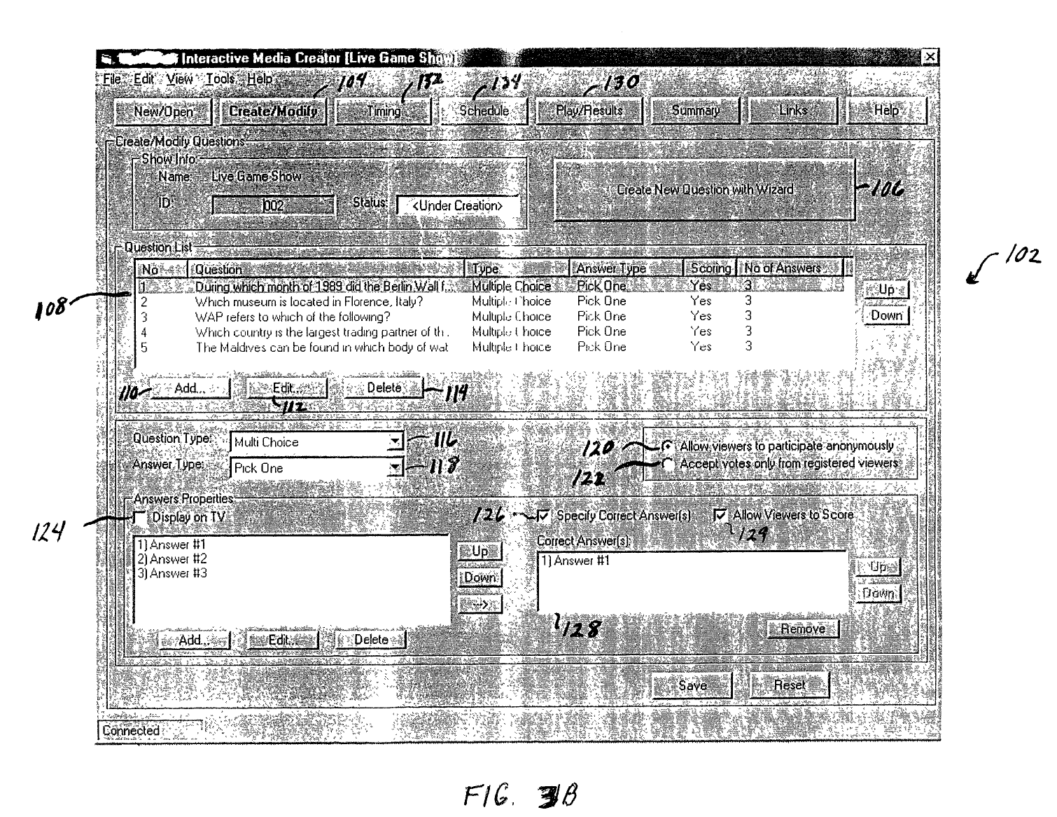

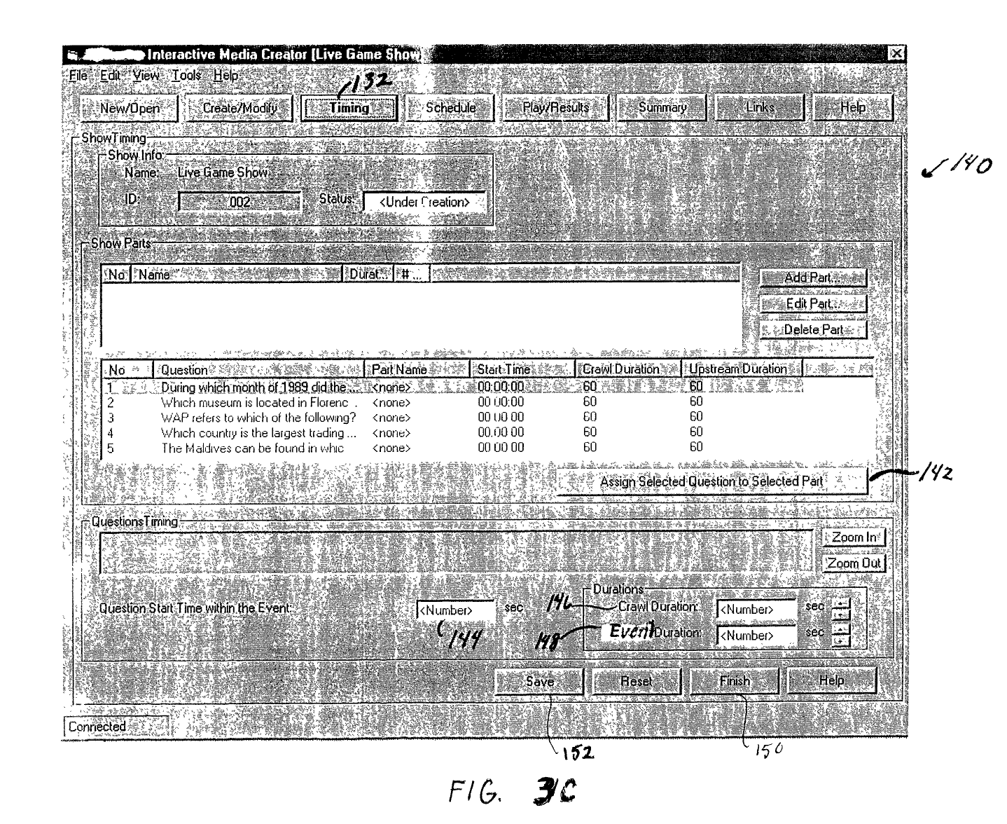

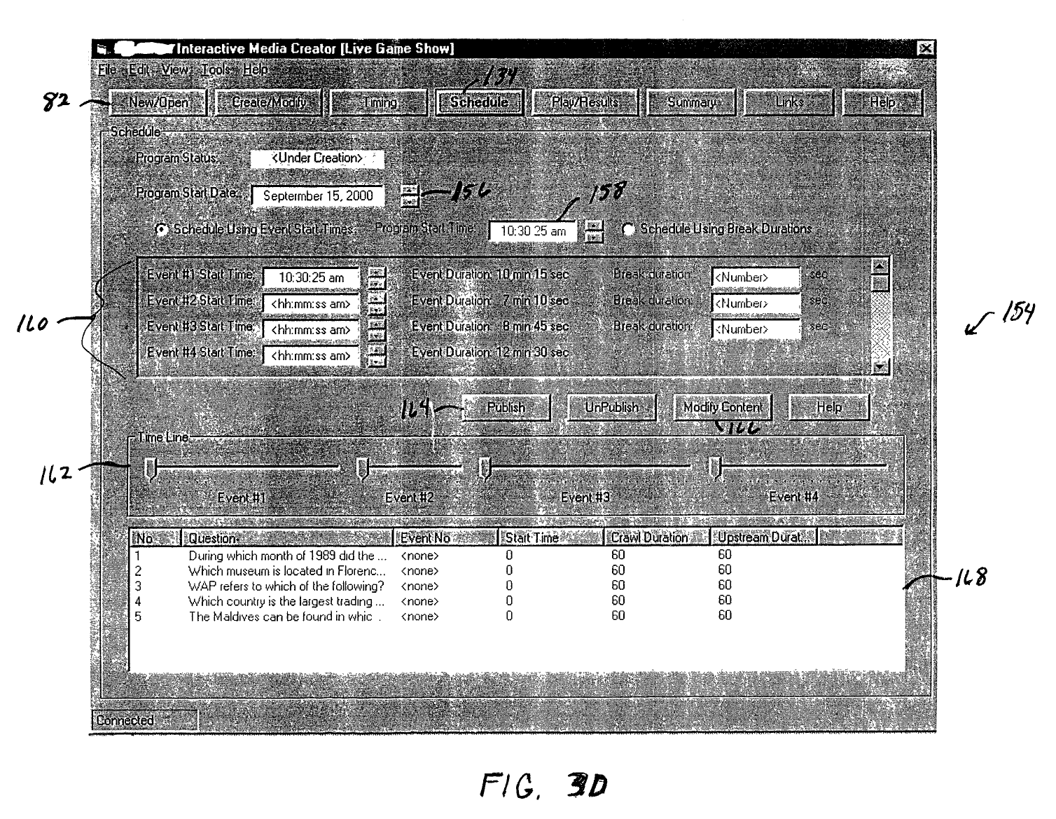

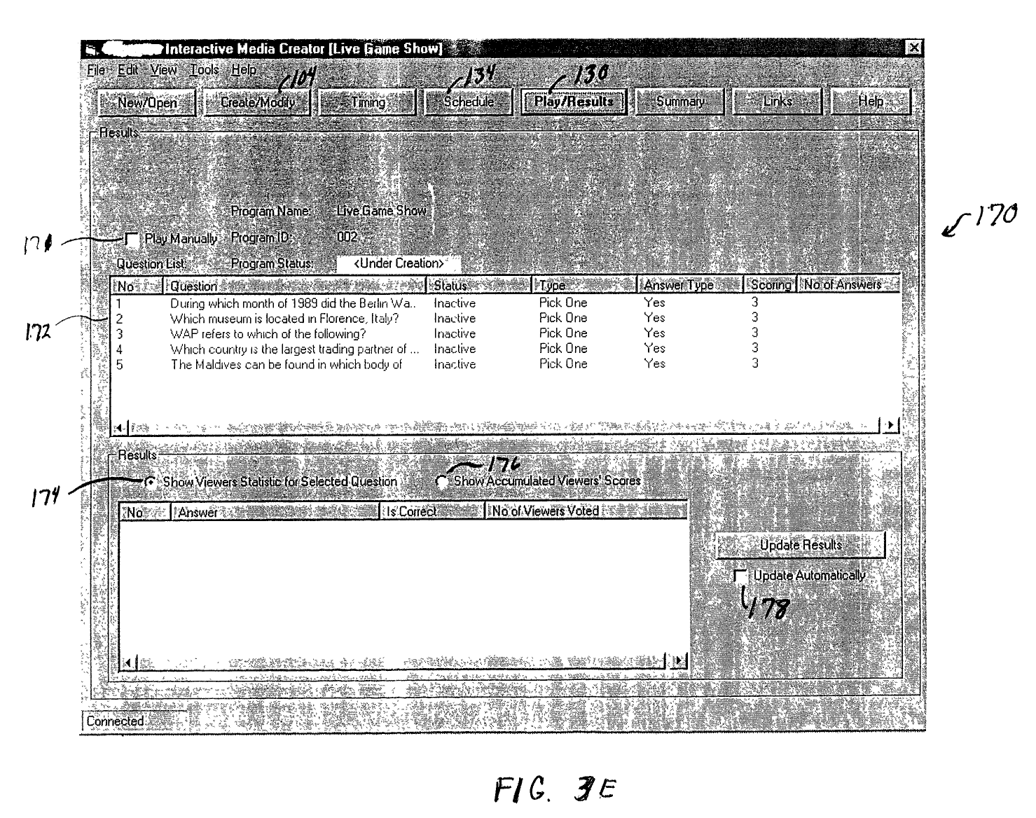

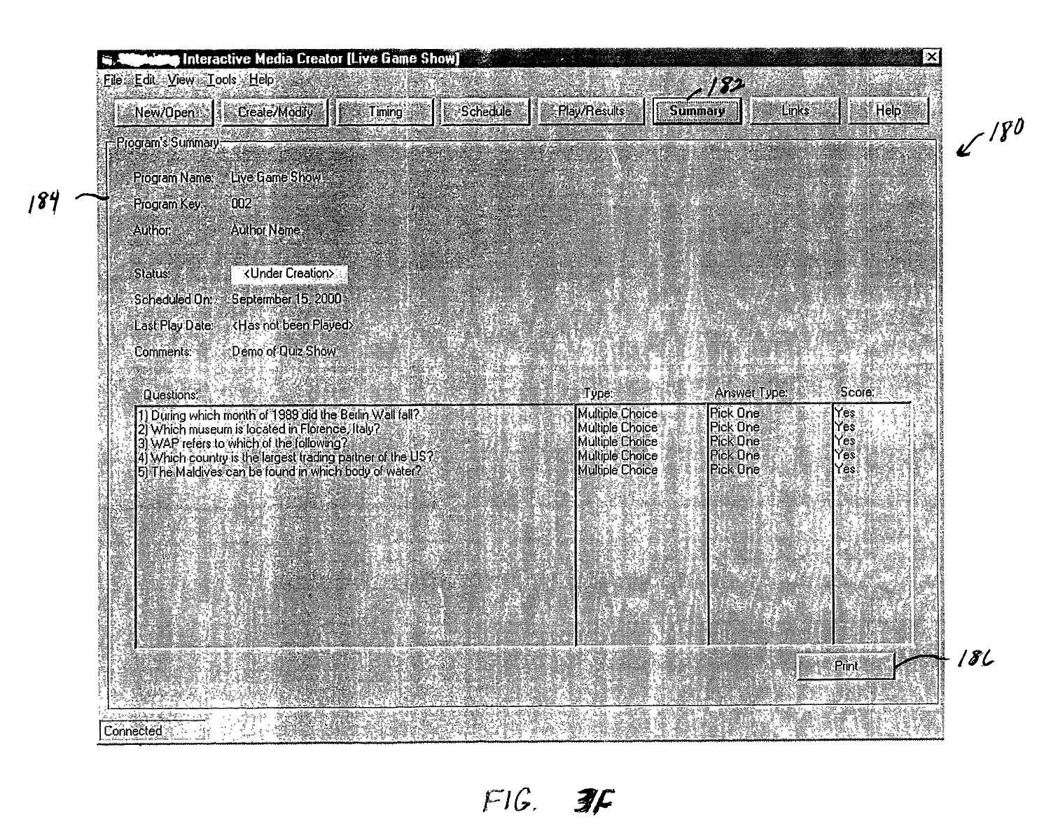

In order to convey the manner in which the interactivity process is set up, various screen displays of the GUI 26 of the IMC system front-end 20 for the television embodiment will now be described with reference to FIGS. 3A through 3F.

Referring to FIG. 3A, a media client representative that has logged onto the IMC system front-end 20 and whose login information (e.g., username and password) has been verified by the server 22 is provided with a start-up screen 80 corresponding to a first tab, “New/Open” 82. On the “New/Open” screen 80, the user is given a choice of displaying a listing of the user's existing files, or files of other IMC system users via a “Display Only My Shows” check box 84. Filters may be applied using an Apply Filters button 86 to a Show List 88 based on such Filter Show List parameters 90 as Show ID 90a, Show Name 90b, Show Status 90c, Author 90d and Play Date 90e. The user is able to sort by categories by clicking on the Show List 88 category tabs 92, including Program ID 92a, Program Name 92b, Status 92c, Author 92d and Last Play Date 92e).

Any existing IMC file has associated with it at any given time one of a number of possible statuses. A group of “Show Status” check boxes 94 selects from a list of possible statuses that includes the following: “Under Creation” 94a; “To Be Scheduled” 94b; “To Be Played” 94c; “Currently Playing” 94d; and “Has Been Played” 94e. The status “Under Creation” 94a indicates that the file is still incomplete and that all of the necessary parameters have not been specified. The status “To Be Scheduled” 94b indicates that the file has been created and time scheduled within the relative duration of the show, and awaits absolute time scheduling. A file having the status “To Be Played” 94c has been scheduled in absolute time by the TV scheduler. Thus, the server 54 knows when to activate and terminate the period for accepting viewer responses to the prompt. If the status of the file is indicated as “Currently Playing” 94d, the prompt is currently active and relevant database data structures are populated. If the prompt has been played, the file status is changed to “Has Been Played” 94e, a status that exists primarily for record keeping purposes (e.g., data mining, billing). Thus, the status of a file changes over time and reflects, for a given point in time, a particular stage in the production process that a program has reached.

In the New/Open tab, the user is provided with options Open Show 96 (to open a show from the displayed Show List 88, Create New Show 98 or Rename Show 100. If the user selects the “Create New Show” option 98, a new window opens and provides the user with several text boxes requiring input: author name (which may be pre-populated from user login data); program name and comments.

After an existing file is opened (using the “Open Show” option 96) or a new one is created (using “Create New Show” option 98), the user is directed to a next page 102 corresponding to a Create/Modify tab 104, shown in FIG. 3B. In this tab, a creative user (such as a producer) prepares new questions with a “Create New Question with Wizard” button 106 and places the questions in a batch Question List 108 using an Add button 110. The user can also edit or delete questions in the Question List using respective edit and delete buttons 112 and 114. The user also specifies the nature of the question in a drop-down Question Type options menu 116 and the nature of the expected answer in a drop-down Answer Type options menu 118. Exemplary question types include the following: multiple choice (shown); “arrange in order” (from a discrete set); and free text. Exemplary answer types include the following: “pick one”; “pick N” (the selection of which causes the system to prompt the user to specify a value for N); “pick all that apply” (where viewer selects from a discrete set of choices); text and number.

The system also allows combinations of question types and answer types, such as:

1. Question: Multiple Choice—Answer: Pick One

2. Question: Multiple Choice—Answer: Pick N

3. Question: Multiple Choice—Answer: Pick Any (up to viewer)

4. Question: Arrange in Order—Answer: Pick N (from a list of M greater or equal to N)

5. Question: Arrange in Order—Answer: Pick Any (up to viewer)

6. Question: Free Text—Answer: Text

7. Question: Free Text—Answer: Numeric

Additional parameters in the question creation process under the Create/Modify tab 104 include the following Answer Properties: parameters allowing viewers to play anonymously 120 or requiring registration 122; a parameter that selects whether or not to display potential answers on TV 124 (a prompt to the scheduler, if different from the producer, to show potential answers on a TV crawl through the character generator); a parameter that provides an indication as to whether there is a correct answer that is expected 126. If there are correct answers, an Answer Properties Correct Answer(s) box 128 allows the user to specify the correct response.

The Answer Properties further provide an “Allow Viewers to Score” check box 130. If the user checks this box, a score is generated for every response (registered or unregistered) and totals are calculated after every new scoring question within the same file. Although not shown, if the question type is free response and the answer type is numeric, the media client representative may be given a choice to specify if the allowed answers are within a given range or if any number is acceptable. On an event Web/WAP site, this kind of question should bring an edit box that only accepts numbers within the range specified. Potential answers are easily re-arranged through either drag-and-drop or side arrows.

After the above parameters have been specified for a given question, the user adds the question to the current show, and the question is featured on the Question List 108. The user can re-edit the elements and parameters of the question by double-clicking on the question in the Question List box 108. Again, the relative order of the questions is easily re-arranged through either drag-and-drop or side arrows.

Optionally, there may be included in the Create/Modify tab page 102 a button “Play Out Now” that brings the user to a Play/Results tab 130. This path is followed as a shortcut if the user is preparing a question “on the fly” and wants to trigger the question manually (from the Play/Results tab 130) for live broadcast.

Otherwise, after questions of the opened or newly created file have been created or modified, the user proceeds to either a Timing tab 132 followed by a Schedule tab 134 (for scheduled broadcasting) or the Play/Results tab 130 (for live broadcasting).

Referring to FIG. 3C, if the show is scheduled for a future (i.e., not live) broadcast, the user uses a Timing tab page 140 corresponding to the Timing tab 132. The Timing tab 132 requires that the user specify the number of discrete parts within the show under production (where a part is defined as continuous program time that has no commercial interruptions). For each question, the user specifies using the Assign Selected Question to Selected Part button 142 the number of a part in which the user wants the interactive prompt to occur. The user specifies in a Question Start Time within the Event field 144 the relative time within that part at which the prompt is to occur.

The user also specifies two additional parameters: the duration of the prompt (i.e., how long the interactive prompt appears on a TV screen) in a Crawl Duration field 146 and duration of the overall event in an Event Duration field 148 (i.e., defining the point up to which the relevant event/WAP site content is active and the application server 54 is accepting responses). By clicking on a “Finish” button 150, the user causes the server to update the Web/WAP site page so that that site is ready to receive viewer's interactions. The time at which the prompt notifies the viewers regarding interactivity (that is, time specified in the Question Start Time Within the Event field 144) is the same or approximately the same as the time that the application server 54 activates the WAP site by invoking application software 60 to serve the WAP site page 64b (that is, the WAP site).

After all questions are scheduled relative to the start time of the part in this manner, the user saves the file using the Save button 152, which causes the status of the file to change from “Under Creation” to “To Be scheduled”.

Referring to FIG. 3D, a Schedule tab page 154 for Schedule tab 134 is used primarily by graphic scheduler users. The graphic schedulers arrive at the Schedule tab 134 from the New/Open tab 82, where they opened a file having a “To Be Scheduled” status. The Schedule tab 134 allows “absolute” timing of a part/event to be specified. The user first specifies a program's Start (Air) Date 156 and Start (Air) time 158. Also specified by the user is the time that each individual event/part starts, in fields 160. Given these parameters, the user is able to position the interactive events on an absolute basis. The relative durations of the prompts and parts, and the server events are portrayed graphically 162, thus highlighting any errors. Additional checks are performed in a background process.

After these absolute times are entered into the IMC system front-end 20, the user presses a Publish button 164, which causes the status of the program and its associated file to become “To Be Played”. The user can also arrive at this screen from New/Open tab (for a file that has a “To Be Played” status) and modify the file's content using a Modify Content button 166, that is, take the file returns to the “Under Creation” status. The results of the absolute scheduling are shown in a table 168.

Referring to FIG. 3E, the user arrives at a page corresponding to the Play/Results tab 130, a page 170 from either the Schedule tab 134 to monitor results when a scheduled show is active and playing or the Create/Modify tab 104 to play out the results live (by manually triggering events). The user specifies such intentions by checking or leaving unchecked the “Play Manually” check box 171. If the user is in the Play/Results tab 130 to watch the scheduled program play out, the user sees the questions becoming active and then inactive in a Question List table 172 listing all of the questions in the file. The user has the choice to specify the type of output or results desired (e.g., by selecting “show viewers statistic for selected question” 174 or “show accumulated viewers' scores” 176). The user is able to specify how the updating is done in the result presentation (manually or periodically scheduled with a specified updating period) by checking or leaving unchecked an “Update Automatically” check box 178, and then clicking an Update Results button 180. If the user arrives at this tab from the “Create/Modify” tab, the user manually triggers each question or prompt of the file, one by one, or triggers the first event and then allows the others to follow at predetermined time intervals.

Referring to FIG. 3F, a Summary page 180 corresponding to a Summary tab 182 provides a Program's Summary 184, which captures all details regarding a file, that is, all of the parameters, questions and potential answers (if applicable) associated with the file. The user is able to print a summary using a “Print” button 186. The tab could be designed to include an e-mail button, enabling the user to mail an electronic copy of the summary to a colleague, or to a CG operator.

The IMC system 19 is able to use both SMS and WAP protocols. Thus, in the initial screen of file creation (the New/Open tab 82), the producer needs to specify if responses should come via SMS, WAP or both, as there are certain question/answer types for which SMS support may not be feasible. By collecting this information during the initial screen, the system is able to alert a user upon posting (that is, when the file goes to the “To Be Scheduled” status).

As noted earlier, the user interface 24 (and associated screen functions) also supports radio and printed media. In implementations for radio and printed media, and returning to FIG. 3B, the button 124 (“display on TV”) is omitted. Also, with reference to FIG. 3C, the concept (and any supporting functionality for) “parts” as described earlier is eliminated for radio and printed media. The questions for a given show (in a radio context) or paper edition (in the printed media context) are assigned to one part. It will be understood that the screen functions are implemented in a manner appropriate to the media. For example, in the printed media context, and still referring to FIG. 3C, the Crawl (question, prompt) and event durations are specified in longer units of time, such as days or weeks, so that the audience is given an appropriate amount of time in which to view and respond to a question.

In the television embodiment described thus far, the IMC system front-end 20 and server 22 are intended for use by TV producers within a live or pre-recorded environment. Schedulers are also users and input absolute time parameters in the IMC system front-end 20. Thus, the IMC system 19 includes three different levels of user access: (i)the producer is able to create/modify files, time prompts within program events, trigger manually; (ii) the scheduler is able to schedule a file in absolute time, as well as trigger manually; and (iii) the supervisor is able to do what most or all users can do and thus may have full authority.

Referring now to FIG. 4, the overall flow of data through the system 10 is shown. It will be understood that the application server 56 uses one version of the database access programs 64, indicated as JSP 68a, XML parser 66a and custom Java class library 70a, to support interactions with the front-end 20, and a second version, indicated as JSP 68b, XML parser 66b and custom Java class library 70b, to support interactions the mobile client. Beginning at the IMC front-end 20, user data is entered into the system. Whenever data is saved by the user (i.e., the user clicks a “save” or “finish” button), the data is transferred to the server 56, where it is stored in the database system 62, and the data as stored is displayed on the front-end 20. The data is stored in the front-end 20 in the form of a data object module (DOM), which is translated into an XML by an XML Parser 200 (which can be implemented as a Visual Basic program as shown) residing on the front-end 20. The XML formatted data is encapsulated as an HTML document by adding an HTML header and is sent to the WWW server 58 via the Internet connection 30 in accordance with HTTP. The WWW server 58 receives the HTML encapsulated XML document and removes the HTML header. The WWW server provides the XML formatted data to the parser 66a and invokes execution of the JRUN program 60. The JRUN program 60 compiles Java pages of the JSP 68a. The JSP 68a runs the parser 66a, which translates the XML data back to DOM format. The JSP 68a then accesses the custom Java class library 70a, which translates the DOM to Structured Query Language (SQL), which is understood by the database system 62. Each field of a DOM is translated to SQL and stored in the database system 62. The JSP 68a uses the Java class library 70a to read what has been stored in the database system 62. The stored data is then converted back to HTML encapsulated XML and sent back to the front-end 20, which uses the received data to update the DOM fields with the data as stored in the database for display to the user. Collectively, application server components 66a, 68a, 70a and 62 perform in this manner the application server portion of an interactive content generation process.

Similarly, the WWW server 58 receives information (an event-associated Web site URL) from the communications device 38 via the WAP gateway 61 and the Internet connection 40. The WWW server 58 converts the information from HTTP to Wireless Markup Language (WML) format and provides the WML data to the JSP 68b, which is compiled by the JRUN program 60. The JSP 68b uses the custom Java class library 70b to translate the WML data to SQL form so that it can read the database system 62. It determines from the program/prompt data stored in the database which program is currently being played and creates for display on the phone 38 the event-associated Web page corresponding to the URL specified by the phone 38. The WWW server 58 receives responses from the phone 38 and the response data is similarly provided to the database system 62, where the response data is stored in association with the program. A daemon program runs in the background of the application server to check with the application server's local clock and compare the time to the stored start time of the programs stored in the database. The clock daemon causes the status of a program whose start time indicates that the program is scheduled to be played soon to be changed to “currently playing”. It also uses a timer to time the event duration and causes the status of the program to changed to “has been played” so no further responses may be received by the WWW server 58 from any audience member after the event as ended. In this manner, the application server components 68a, 70b and 62 perform an application server portion of a response processing process that processes each viewer response based on the stored program/prompt data.

What is claimed is:

1. A method of enabling interactive communications between mass media operators and mass media audiences comprising:
associating an interactive prompt with a communication of a mass communications medium, so that the interactive prompt is received by an audience member; and
receiving a response from the audience member in response to the interactive prompt from a communications device.

2. The method of claim 1, wherein the communications medium comprises a television broadcast network and the communication comprises a television program.

3. The method of claim 1, wherein the mass communications medium comprises a radio broadcast network and the communication is a radio program.

4. The method of claim 1, wherein the mass communications medium comprises a print medium and the communication is an issue of a printed publication.

5. The method of claim 2, wherein communications device operates according to a wireless communications medium protocol.

6. The method of claim 5, wherein the communications device is a mobile telephone and the wireless communications medium protocol is Wireless Access Protocol.

7. The method of claim 1, wherein the communications medium protocol is Hyper-Text Transfer Protocol.

8. The method of claim 2, wherein associating comprises:
providing the prompt for insertion in the television program prior to a transmission of the television program over a television broadcast transmission medium to a television receiver.

9. The method of claim 8, wherein providing comprises providing the prompt to a character generator for insertion in the television program as text.

10. The method of claim 8, wherein providing further comprises providing the prompt for insertion in the television program as audio.

11. The method of claim 2, wherein receiving further comprises:
providing a Web site to receive the response.

12. The method of claim 8, wherein associating further comprises:
receiving data concerning the interactive prompt, the data including time scheduling of the interactive prompt within the broadcast.

13. The method of claim 12, wherein providing further comprises:
providing the Web site to receive the response based on the time scheduling of the interactive prompt within the broadcast.

14. The method of claim 8, wherein the television broadcast transmission medium is cable.

15. The method of claim 8, wherein the television broadcast transmission medium is satellite.

16. The method of claim 8, wherein the television broadcast transmission medium is terrestrial.

17. The method of claim 8, wherein the television broadcast transmission medium is aerial.

18. The method of claim 3, wherein associating comprises:
providing the prompt for insertion in the radio program prior to a transmission of the radio program over a radio broadcast transmission medium to a radio receiver.

19. The method of claim 18, wherein the radio broadcast transmission medium is aerial.

20. The method of claim 18, wherein the radio broadcast transmission medium is a digital transmission medium.

21. The method of claim 4, wherein associating comprises:
providing the prompt for insertion in the printed publication prior to a delivery of the printed publication over a printed communication medium to the audience member.

22. The method of claim 21, wherein the print communication medium is a paper publication.

23. The method of claim 21, wherein the print communication medium is a digital medium.

24. The method of claim 21, wherein the print communication medium is a billboard advertisement located in a public place.

25. The method of claim 5, wherein the communications device is a mobile telephone and the wireless communications medium protocol is Short Message Service.

26. The method of claim 1, wherein the communications device is a handheld computing device.

27. A computer program product residing on a computer readable medium for enabling interactive communications between mass media operators and mass media audiences, comprising instructions for causing a computer to:
associate an interactive prompt with a communication of a mass communications medium by an operator of the mass communications medium so that the prompt is received by a member of an audience of the communication; and
enable the audience member to provide a response to the interactive prompt using a communications device that operates according to an Internet communications protocol.

28. A computer program product residing on a computer readable medium for enabling communications between mass media operators and mass media audiences, comprising instructions for causing a computer to:
generate a prompt for inclusion in a broadcast of a program;
associate timing parameters with the prompt to schedule an occurrence of the prompt within the program;
associate the prompt and the program with a Web site; and
use the timing parameters to control the associated Web site to receive responses to the prompt from members of an audience of the program.

29. A server system comprising:
a server configured to exchange communications with a client computer, the communication exchanges of a type that enables the client to associate timing parameters and attributes with an interactive prompt played during a program, and associate the interactive prompt with a Web site supported on the server so that the Web site is prepared to receive responses to the prompt from viewers.

30. The server system of claim 29, further comprising: a database coupled to the server;
wherein the server adds an entry for the interactive prompt in the database and stores the responses received from viewers in the database entry; and
wherein the server communicates the responses to the client computer for viewing by a user of the client computer.
